(19) United States
(12) Patent Application Publication
(10) Pub. No.: US 2002/0094806 A1
(43) Pub. Date: Jul. 18, 2002

(54) Communication apparatus for use in a communication system providing caller ID functionality

(75) Inventor: Sawa Kamimura, Kanagawa (JP)

Correspondence Address: BANNER & WITCOFF, 1001 G STREET N W, SUITE 1100, WASHINGTON, DC, 20001, US

(73) Assignee: Kabushiki Kaisha Toshiba, Minato-ku (JP)

(21) Appl. No.: 10/000,804

(22) Filed: Dec. 4, 2001

(30) Foreign Application Priority Data
Dec. 7, 2000 (JP) 2000-373257

(51) Int. Cl. H04M 3/42

(52) U.S. Cl. 455/415; 455/567; 455/564

(57) ABSTRACT

A telephone directory stores a plurality of data sets including a name, a telephone number, e-mail address, image pattern numbers, a ring tone number, a background color number, and a vibrating pattern. An image memory stores images corresponding to each image pattern number. A ring tone memory stores ring tone data corresponding to each ring tone pattern. When a radio communication apparatus receives an incoming call signal, the control unit informs of an incoming voice or message call by repeatedly displaying the images on a display unit.

### RELATED APPLICATION INFORMATION

This application claims priority under 35 U.S.C. §119 to Japanese patent application P2000-373257.

### FIELD OF THE INVENTION

The present invention relates to a communication apparatus for use in a communication system that provides caller identification (caller ID) information for identifying a calling party that requests communication with the communication apparatus.

### DESCRIPTION OF THE RELATED ART

Radio communication apparatuses, for example, cellular phones, can send and receive short text messages or electronic mail (e-mail). In addition, cellular phones can store a calling party's telephone number and name corresponding to caller ID information in a telephone directory. In addition, cellular phones can store a message address or an e-mail address in a telephone directory in correspondence with the calling party's telephone number.

Cellular phones can be programmed to select a ringing tone for notifying a called party of an incoming call or a received message. A ringing tone can be set to correspond with a telephone number, a message address or an e-mail address stored in a telephone directory. When the cellular phone receives caller ID information from a network, the cellular phone can display the name of the calling party in correspondence with the received caller ID by comparing the received caller ID with the stored telephone number.

Also, the cellular phone can alert the called party of the incoming call with using the set ringing tone in correspondence with the caller ID information associated with the incoming call.

However, present cellular phones can only store a maximum of several hundred-telephone numbers in the telephone directory. Thus, a user of the cellular phone can have a difficult time in identifying a caller with the ringing tone in correspondence with the caller ID data.

Furthermore, upon receiving an incoming call, the cellular phone can display the stored name of the calling party in correspondence with the caller ID information. However, in the case that the called party has information stored for two different parties with very similar names (e.g., the names “Yamashita” and “Yamashito”), when the cellular phone displays the name of the caller, the user of the cellular phone may not be able to identify the caller from the displayed name.

### SUMMARY

The present invention addresses many of the shortcomings with the prior art set forth above. One aspect of the invention is to provide a highly convenient communication apparatus capable of easily identifying a calling party when the apparatus receives an incoming call signal or an incoming message signal.

According to one aspect of the invention, a communication apparatus is capable of receiving identification data for identifying a calling party and its communication apparatus. In a further aspect of the invention, a communication apparatus comprises: a memory configured to store a plurality of images corresponding to identification data; a detector configured to detect the identification data in an incoming call to the communication apparatus; a controller configured to retrieve the images corresponding to the detected identification data from the memory; and a display configured to display the retrieved images.

In another aspect of the invention, a communication apparatus can provide a notification that the apparatus has received an incoming call signal or incoming message signal, where the apparatus can repeatedly display images previously stored in a storing unit. The images are stored in correspondence with the identification data in the storing unit. Therefore, the apparatus can help a user to identify a caller easily by looking at the displayed images.

### BRIEF DESCRIPTION OF THE DRAWINGS

FIG. 1 is a circuit block diagram illustrating an exemplary embodiment of a radio communication apparatus according to the present invention.

FIG. 2 is an exemplary memory data table stored in the telephone directory of the illustrative radio communication apparatus shown in FIG. 1.

FIG. 3 is a flowchart illustrating an exemplary process for registering personal data in the telephone directory of a radio communication apparatus shown in FIG. 1.

FIG. 4 is a first example of images displayed on a display unit in the process shown in FIG. 3.

FIG. 5 is a second example of images displayed on a display unit in the process shown in FIG. 3.

FIG. 6 is a third example of images displayed on a display unit in the process shown in FIG. 3.

FIG. 7 is a fourth example of images displayed on a display unit in the process shown in FIG. 3.

FIG. 8 is a flowchart illustrating an exemplary process for receiving an incoming call signal in the radio communication apparatus shown in FIG. 1.

FIG. 9 is one example of images displayed on a display unit in the process shown in FIG. 8.

FIG. 10 is a flowchart illustrating an exemplary process for receiving an incoming message signal in the radio communication apparatus shown in FIG. 1.

FIG. 11 is one example of images displayed on a display unit in the process shown in FIG. 10.

### DETAILED DESCRIPTION OF THE EMBODIMENTS

Hereafter, an illustrative embodiment of the present invention will be described with reference to the drawings.

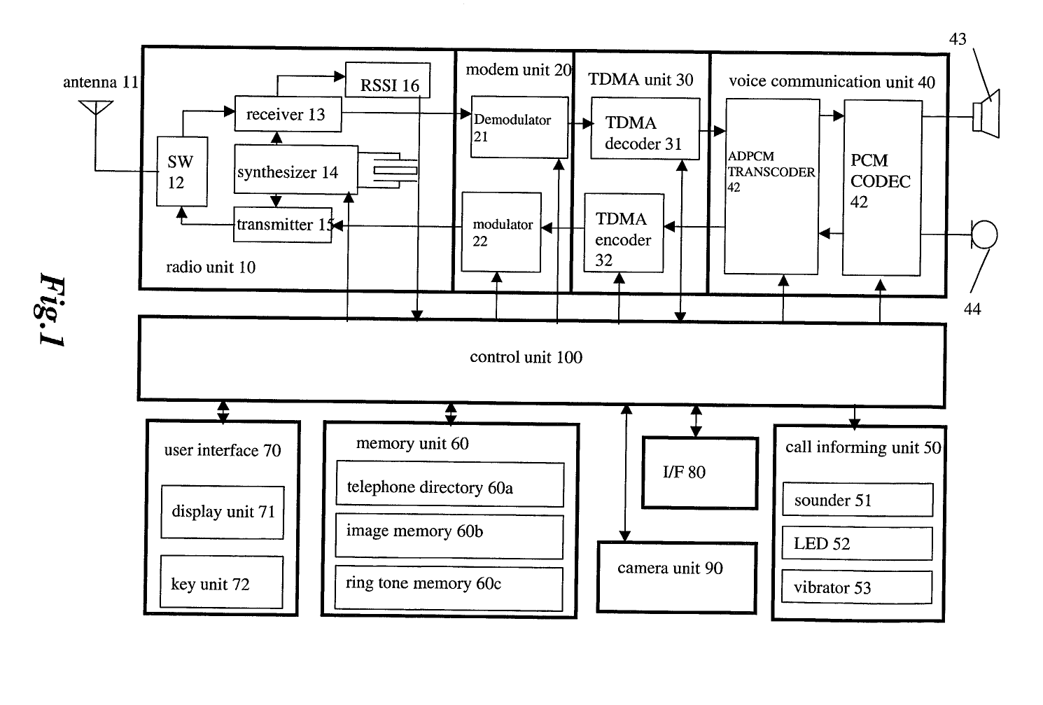

FIG. 1 shows a configuration of a radio communication apparatus according to an illustrative embodiment of the invention. Here, the radio communication apparatus that performs radio communication with the base station by TDMA (Time Division Multiple Access) will be exemplified.

The radio communication apparatus shown in FIG. 1 comprises a radio unit 10 connected to an antenna 11, a modem unit 20, a TDMA unit 30, a voice communication unit 40 connected to a speaker 43 and a microphone 44, a call informing unit 50, a memory unit 60, a user interface unit 70 and a control unit 100.

The antenna 11 receives a radio frequency signal transmitted from a base station connected to a mobile radio communication network over a radio channel. Then, the received radio frequency signal is inputted to a receiver 13 through a high frequency switch (SW) 12 in the radio unit 10.

The receiving unit 13 mixes the received radio frequency signal with a local oscillating signal generated by a frequency synthesizer 14 and changes the radio frequency signal to an intermediate frequency signal.

The frequency synthesizer 14 generates the local oscillating signal in accordance with a frequency in a radio channel assigned by the control unit 100.

The radio unit 10 has a received signal strength indicator (RSSI) detecting unit 16. The RSSI detecting unit 16 detects electric field strength in the radio frequency signal transmitted from the base station and notifies the control unit 100 of the detected strength.

The intermediate frequency signal outputted from the receiving unit 13 is inputted to a demodulator 21 in the modem unit 20. The demodulator 21 demodulates the inputted intermediate frequency signal and outputs a digital voice communication signal.

A TDMA decoder 31 in the TDMA unit 30 decomposes the digital voice communication signal in every time slot in accordance with instructions received from the control unit 100.

Then, among a plurality of the decomposed digital voice communication signals, the slot of the digital voice communication signal for the radio communication apparatus is input to the voice communication unit 40.

The voice communication unit 40 comprises an ADPCM (adaptive pulse code modulation) transcoder 41 and a PCM (pulse code modulation) codec 42. The ADPCM transcoder 41 and the PCM codec 42 decode the digital voice communication signal sequentially and generate an analog voice communication signal. Then, the generated analog voice communication signal is amplified and outputted to the speaker 43.

The voice data inputted from the microphone 44 is sequentially coded by the ADPCM transcoder 41 and the PCM codec 42. The ADPCM transcoder 41 and the PCM codec 42 generate a digital voice communication signal that is then output to a TDMA encoding unit 32.

The TDMA encoding unit 32 inserts the digital voice communication signal into a time slot assigned by the control unit 100. The TDMA encoding unit 32 inputs the inserted digital voice communication signal to the modulator 22.

The modulator 22 modulates the inputted digital communication signal to a carrier signal and inputs the carrier signal to the transmitter 15.

The transmitter 15 mixes the inputted carrier signal with an oscillating signal generated by the frequency synthesizer 14 and changes the carrier signal to a radio frequency signal adapted in a radio channel. Then, the radio frequency signal is amplified to a predetermined transmitting power level. The amplified radio frequency signal is transmitted from the antenna 11 through the high frequency switch 12 to the base station.

The call informing unit 50 informs a user of an incoming call. The incoming call can be an incoming voice call or an incoming message call.

The call informing unit 50 comprises sounder 51, LED (light emitting diode) 52 and vibrator 53. The sounder 51 informs of an incoming call by generating a ring tone. The LED 52 informs of an incoming call by emitting light. The vibrator 53 informs of an incoming call by generating vibration.

A memory unit 60 may be a semiconductor memory such as a ROM or a RAM as a storage medium. The memory unit 60 comprises a telephone directory 60a, an image memory 60b and a ring tone memory 60c. The memory unit 60 also stores a control program executed by the control unit 100, the ID data of the communication apparatus required for authentication, a variety of control data, a variety of setting data, created message data or received message data.

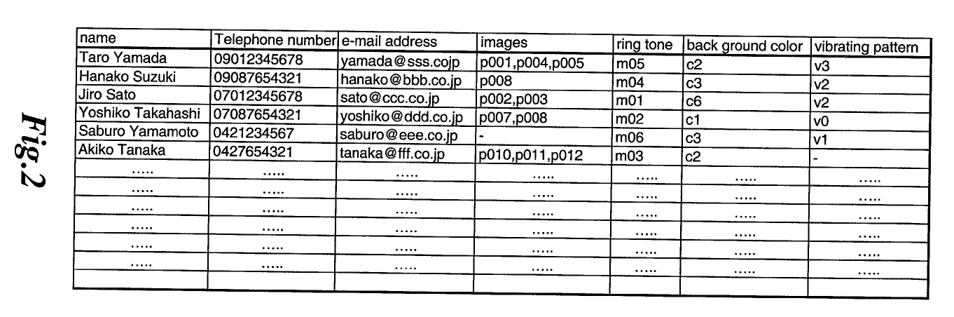

The telephone directory 60a is an area for storing a telephone directory data. As shown in FIG. 2, the telephone directory 60a can store names and e-mail addresses in correspondence with each telephone number.

The telephone directory 60a also stores image pattern numbers (p000-p999) in correspondence with each telephone number. An image that corresponds to a pattern number is displayed on a display unit when the radio communication apparatus receives an incoming call from a party whose caller ID information is stored as a telephone number in the telephone directory.

The telephone directory also stores ring tone patterns (m00-m99) in correspondence with each telephone number. The sounder 51 generates a ring tone that corresponds to the ring tone pattern when the radio communication apparatus receives an incoming call from a party whose caller ID is stored as a telephone number in the telephone directory.

The telephone directory also stores a background color pattern number (c0-c9) in correspondence with each telephone number. The LED 52 illuminates the display unit 71 using the color that corresponds to the background color pattern when the radio communication apparatus receives an incoming call from a party whose caller ID is stored as a telephone number in the telephone directory.

The telephone directory also stores a vibrating pattern number (v0-v9) in correspondence with each telephone number. The vibrator 53 generates vibration using the vibrating pattern that corresponds to the vibrating pattern number when the radio communication apparatus receives an incoming call from a party whose caller ID is stored as a telephone number in the telephone directory.

The image memory 60b stores images such as photographs, illustrations or icon data. It is contemplated that images is not limited to still images, but may include moving images. Each images corresponds with an image pattern number. Additionally, the images stored in the image memory 60b can be added by downloading the images from a network through the base station, inputting the images from an external interface (I/F) 80 or a camera 90, described later.

The ring tone memory 60c stores ring tone data. Each ring tone data corresponds with a ring tone pattern number. In addition, the ring tone data stored in the ring tone memory 60c can be added by downloading the ring tone data from a network through the base station, or inputting the ring tone data from an external interface (I/F) 80, described later.

The user interface unit 70 comprises a display unit 71 and a key input unit 72. The display unit 71 can be an LCD (Liquid Crystal Display), for example, which displays states of the apparatus, the telephone number read out from the telephone directory 60a, and data such as an e-mail message or images.

The key input unit 72 comprises some keys for inputting data. One or more of the keys can be used for inputting a telephone number for making a call. One or more of the keys can be used for switching a call informing method among the sounder 51, the LED 52 or the vibrator 53. One or more of the keys can be used for setting a ring tone for informing a user of an incoming call. One or more of the keys can be used for inputting text characters.

An external interface 80 is capable of connecting to an external device such as a PDA (Personal Digital Assistant) or a personal computer. The radio communication apparatus can output data to the external interface 80 and input data from the external interface 80. The control unit 100 can control the inputting and outputting between the radio communication apparatus and the external device.

An electronic camera 90 comprising an image acquisition device such as a CCD (Charge-Coupled Device) or a CMOS (Complementary Metal Oxide Semiconductor) can acquire images. The camera 90 outputs the acquired images to the control unit 100.

A control unit 100 comprises a microprocessor as a main control unit, for example, for controlling each unit described. The control unit 100 has a variety of control functions such as voice communication by the TDMA or sending and receiving messages, for example, e-mail.

Additionally, the control unit 100 has an editing function for editing data stored in the telephone directory 60a and an informing function for informing of an incoming call in accordance with the data stored in the telephone directory 60a when the radio communication apparatus receives the incoming call. The control unit 100 has a detecting function for detecting caller ID information included in an incoming call signal and for detecting an e-mail address included in an incoming message signal. An incoming message signal can include text messages, e-mail messages, short messages, video messages, and multimedia messages.

Furthermore, not shown in FIG. 1, there is a power source unit having a battery, capable of repeatedly charging and discharging, and for supplying electric power to operate each unit mentioned above as a component of the apparatus.

Next, operation of the radio communication apparatus having the above configuration will be described. Additionally, in the following operational description, the editing operation for the telephone directory 60a and the informing operation when an incoming call for voice communication or message communication occurs according to an embodiment of present invention will be described. These operations are performed by the control of the control unit 100.

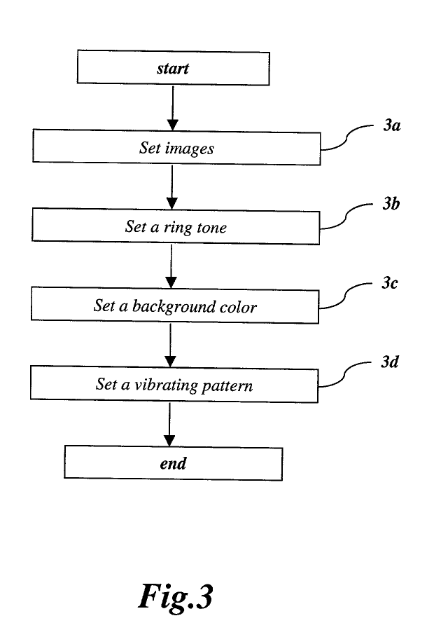

First, a process in the editing operation for the telephone directory 60a will be described. FIG. 3 is a flowchart showing this process.

The process is started when a user makes an editing request for the telephone directory data by the key input unit 72.

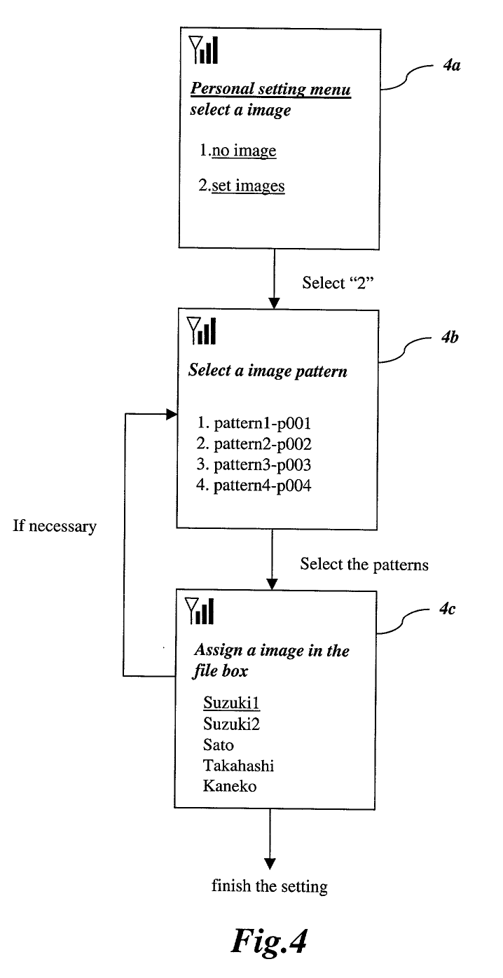

At first, the control unit 100 sets images displayed on the display unit 71 when an incoming call is received. The display unit 71 displays the data shown in FIG. 4(a) for entering data to set the images (step 3a).

When “set images” is selected from the personal menu in FIG. 4(a) (step 3a), the display unit 71 displays the menu shown as FIG. 4(b).

At this time, the user selects the image pattern to be associated with the incoming call. As shown in FIG. 4(C), an image in a file box is assigned to the incoming call. The selected image pattern corresponds to the assigned image. The file box shows the names given to the items of the identification information of the image patterns p000 to p999 to be stored as a list in the image memory 60b.

After assigning the images, the assigned image patterns are stored in the telephone directory 60a shown in FIG. 2. For example, in FIG. 2, the telephone directory has image patterns p001, p004 and p005 as the images from the first pattern up to the third pattern in a memory area of “Taro Yamada”.

When “no images” is selected (step 3a) from the menu in FIG. 4(a), no image pattern is stored in the telephone directory 60a. For example, in FIG. 2, the telephone directory has no image pattern in a memory area of “Saburo Yamamoto”.

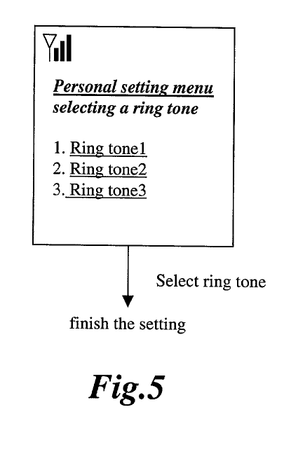

At step 3b shown in FIG. 3, the control unit 100 sets a personal ring tone in accordance with data inputted using the key unit 72. The sounder 51 generates the set ring tone when the apparatus receives an incoming voice or message call. At first, a display unit 71 displays the data as shown in FIG. 5 and the control unit 100 sets a personal ring tone in the telephone directory 60a. After setting the personal ring tone, the set personal ring tone, which is one of ring tones m00-m99, is stored in the telephone directory 60a shown in FIG. 2. For example, in FIG. 2, the telephone directory has a ring tone m05 in a memory area of “Taro Yamada”.

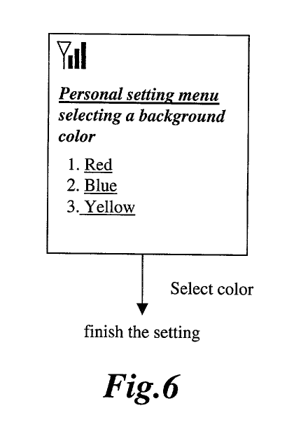

At step 3c shown in FIG. 3, the control unit 100 sets a personal background color in accordance with data inputted by the key unit 72. The background color is used on the display unit 71 when the apparatus receives an incoming voice or message call. At first, a display unit 71 displays the data as shown in FIG. 6 and the control unit 100 sets a personal background color in the telephone directory 60a. After setting the personal background color, the set personal background color, which is one of background patterns c0-c9, is stored in the telephone directory 60a shown in FIG. 2. For example, in FIG. 2, the telephone directory has a background color c2 in a memory area of “Taro Yamada”.

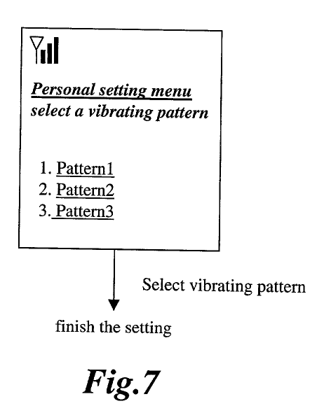

At step 3d shown in FIG. 3, the control unit 100 sets a personal vibrating pattern in accordance with data inputted by the key unit 72. The vibrator 53 generates a vibration with the set pattern when the apparatus receives an incoming voice or message call. At first, a display unit 71 displays the data as shown in FIG. 7 and the control unit 100 sets a personal vibrating pattern in the telephone directory 60a. After setting the personal vibrating pattern, the set personal vibrating pattern, which is one of vibrating patterns v0-v9, is stored in the telephone directory 60a shown in FIG. 2. For example, in FIG. 2, the telephone directory has a vibrating pattern v3 in a memory area of “Taro Yamada”. The telephone directory also has no vibrating pattern in a memory area of “Akiko Tanaka”.

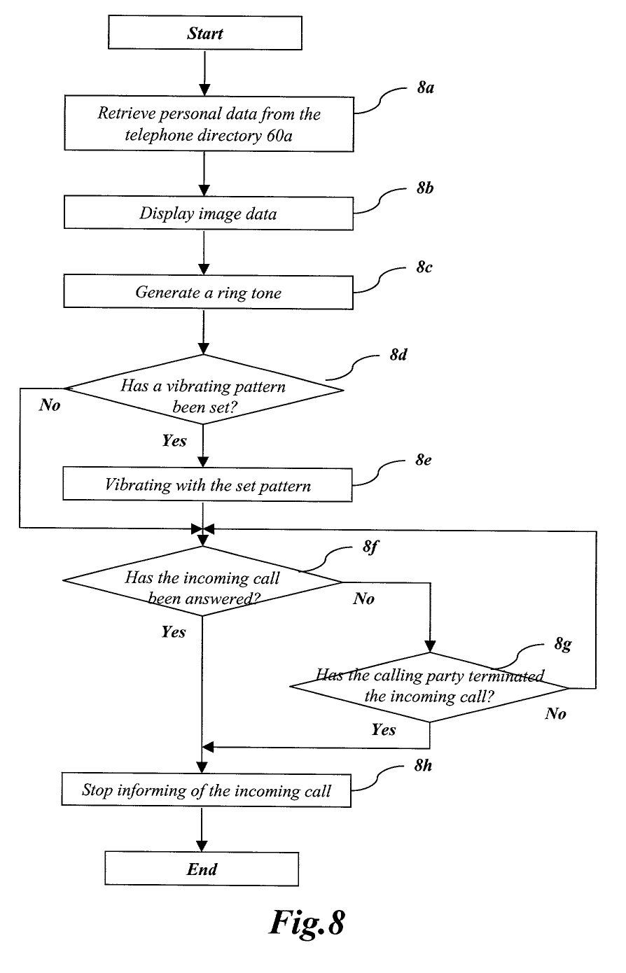

Next, the process in the radio communication apparatus when the apparatus receives an incoming call signal will be described. FIG. 8 is a flowchart illustrating this process. The process starts when the apparatus receives an incoming call signal.

At step 8a, the control unit 100 retrieves personal data from the telephone directory 60a corresponding to caller ID information. The caller ID information is included in the received incoming call signal. The telephone number included in the personal data corresponds to caller ID information. The caller ID information is provided by a network through a base station and included in the incoming call signal. Then the control unit 100 reads the personal data from the telephone directory 60a, and proceeds to step 8b.

At step 8b, the display unit 71 displays personal images corresponding to the personal data read from the telephone directory 60a. The displayed images are stored in the image memory 60b.

Then, these images are displayed on the display unit 71 in the order set in the personal data read from telephone directory 60a. The background color corresponding to the personal data read is used.

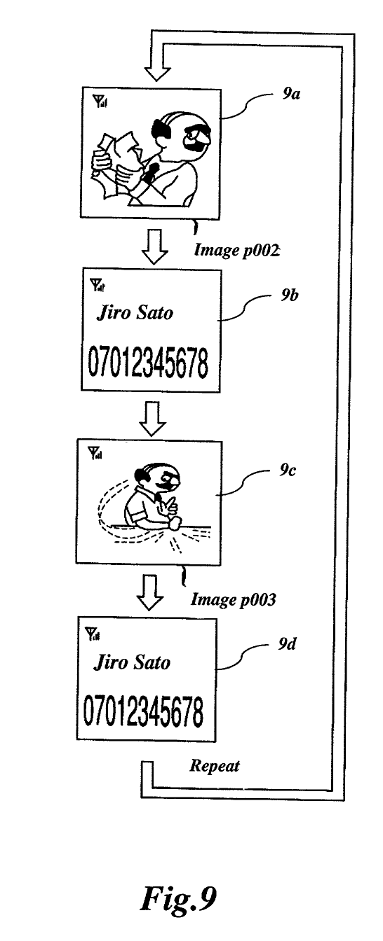

Additionally, the images read from the telephone directory 60a are displayed on the display unit 71 in the order set in the personal data in telephone directory 60a. As shown in FIG. 9, the display unit 71 displays data including the name and number of the calling party, which is included in the personal data read from the telephone directory 60a, while switching the images.

At step 8c, the sounder 51 generates a ring tone corresponding to the ring tone pattern included in the personal data read from the telephone directory 60a. The ring tone is stored in the ring tone memory 60c.

At step 8d, the control unit 100 determines if the personal data read from the telephone directory has a vibrating pattern. When the personal data has a vibrating pattern, the flowchart proceeds to the step 8e. When the personal data has no vibrating pattern, the flowchart proceeds to step 8f.

At the step 8e, the vibrator 53 generates a vibration that corresponds to the vibrating pattern included in the personal data read from the telephone directory 60a.

At step 8f, the control unit 100 determines if the user answers the incoming call with the key unit 72. When the user answers the incoming call, the flowchart proceeds to step 8h. When the user does not answer the incoming call, the flowchart proceeds to step 8g.

At step 8g, the control unit 100 determines if the incoming call is terminated. When the incoming call is terminated, the flowchart proceeds to step 8h. When the incoming call is not terminated, the flowchart proceeds to step 8f.

At step 8h, the control unit 100 stops displaying the images at step 8b, stops generating the ring tone at step 8c and stops generating the vibration at step 8e.

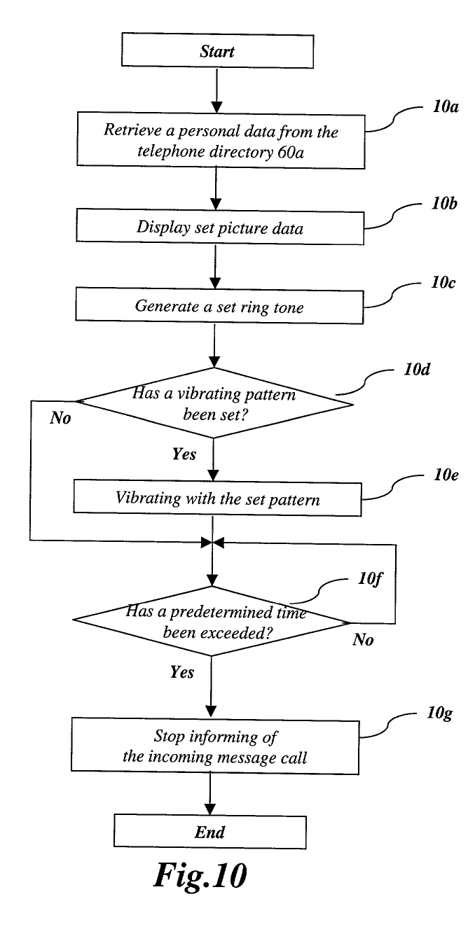

Next, the process in the radio communication apparatus when the apparatus receives an incoming message signal will be described. FIG. 10 is a flowchart illustrating this process.

The process starts when the apparatus receives an incoming message signal.

At step 10a, the control unit 100 detects an e-mail address in the received incoming message signal and starts counting a time. The control unit 100 retrieves personal data from the telephone directory 60a corresponding to caller ID information associated with the received incoming message signal. The personal data includes the detected e-mail address. The control unit 100 reads the retrieved personal data.

At step 10b, the display unit 71 displays images corresponding to the image patterns included in the personal data read from the telephone directory 60a. The displayed images are stored in the image memory 60b.

Then, these images are displayed on the display unit 71 in the order set in the personal data read from telephone directory 60a. The background color corresponding to the personal data read is used.

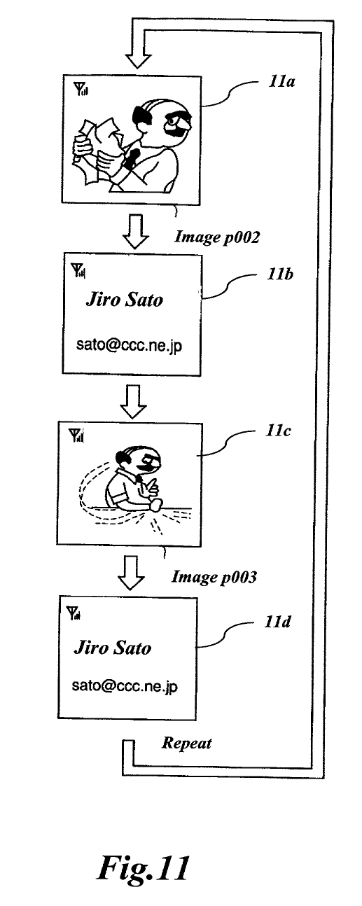

Additionally, the images read are displayed on the display unit 71 in the order set in the personal data in telephone directory 60a. As shown in FIG. 11, the display unit 71 displays the data including the e-mail address and the name of the calling party included in the personal data read while switching the images.

At step 10c, the sounder 51 generates a ring tone corresponding to the ring tone pattern included in the personal data read from the telephone directory 60a. The ring tone is stored in the ring tone memory 60c.

At step 10d, the control unit 100 determines if the personal data read from the telephone directory 60a has a vibrating pattern. When the personal data read has a vibrating pattern, the flowchart proceeds to step 10e. When the personal data read has no vibrating pattern, the flowchart proceeds to step 10f.

At step 10e, the vibrator 53 generates a vibration corresponding to the vibrating pattern included in the personal data read from the telephone directory 60a.

At step 10f, the control unit 100 determines if the counted time exceeds the predetermined time. When the counted time exceeds the predetermined time, the flowchart proceeds to step 10g. When the counted time does not exceed the predetermined time, the flowchart proceeds to step 10f.

At step 10g, the control unit 100 stops displaying the images at step 10b, stops generating the ring tone at step 10c and stops generating the vibration at step 10e.

As described above, when a radio communication apparatus informs that an incoming call signal or incoming message signal is being received, the radio communication apparatus can repeatedly display the images set in a telephone directory in advance of answering the incoming call or reading the incoming message. The images are set corresponding to a telephone number in the telephone directory. Therefore, the radio communication apparatus can help a user identify a caller easily by looking at the displayed images.

Additionally, when the apparatus informs a user of an incoming call or incoming message by displaying the images, the apparatus can display a plurality of images repeatedly.

Therefore, multiple images can be assigned to a telephone number in the telephone directory, for example images can include a image of the calling party as well as images which indicates the company or school associated with the calling party. Thus, the radio communication apparatus can help a user identify a caller easily by looking at the displayed images.

Furthermore, in addition to informing a user of an incoming call or incoming message by displaying the set images in the telephone directory, the radio communication apparatus can inform the user of an incoming call by generating the set ring tone and the set vibration in the telephone directory.

In this embodiment, the radio communication apparatus has been exemplified. However, this invention is not limited to the above, and can be applied to a communication apparatus in a wired communication.

Also, in the illustrative embodiment, when the radio communication apparatus receives an incoming message signal, the control unit 100 retrieves personal data from the telephone directory 60a on the basis of the detected e-mail address. However, the present invention is not limited to this implementation. For example, if the telephone number is assigned as an address for sending or receiving a text message, the control unit 100 can retrieve personal data on the basis of the detected telephone number.

What is claimed is:

1. A communication apparatus comprising:
a memory configured to store a plurality of images corresponding to identification data;
a detector configured to detect the identification data in an incoming call to the communication apparatus;
a controller configured to retrieve the images corresponding to the detected identification data from the memory; and
a display configured to display the retrieved images.

2. The radio communication apparatus according to claim 1, wherein the identification data identifies a caller requesting voice communication with the communication apparatus.

3. The communication apparatus according to claim 1, wherein the identification data identifies a caller requesting message communication with the communication apparatus.

4. The communication apparatus according to claim 1, wherein the memory stores other data corresponding to the identification data, the controller retrieves the other data from the memory corresponding to the detected identification data, and the display alternates between displaying individual ones of the retrieved images and the retrieved other data.

5. The communication apparatus according to claim 4, wherein the other data includes a name.

6. The communication apparatus according to claim 1, further comprising;
a ringing unit configured to generate a ring tone;
wherein the memory stores a ring tone corresponding to the identification data and the controller retrieves the ring tone corresponding to the detected identification data and causes the ringing unit to generate the retrieved ring tone.

7. The communication apparatus according to claim 1, further comprising:
a vibrating unit configured to generate vibration;
wherein the memory stores a vibrating pattern corresponding to the identification data and the controller retrieves the vibrating pattern corresponding to the detected identification data and causes the vibrating unit to generate the retrieved vibrating pattern.

8. The communication apparatus according to claim 1, wherein the images are still images.

9. The communication apparatus according to claim 1, wherein the images include moving images.

10. In a communication apparatus, a method comprising:
storing in a memory a plurality of images corresponding to identification data;
detecting the identification data in an incoming call to the communication apparatus;
retrieving the images corresponding to the detected identification data from the storing unit; and
displaying the retrieved images on a display.

11. The method according to claim 10, wherein the identification data identifies a caller requesting voice communication with the communication apparatus.

12. The method according to claim 10, wherein the identification data identifies a caller requesting message communication with the communication apparatus.

13. The method according to claim 10, wherein said storing further comprises storing other data corresponding to the identification data, said retrieving further comprises retrieving the other data from the memory corresponding to the detected identification data, and said displaying further comprises alternately displaying individual ones of the retrieved images and the retrieved other data.

14. The method according to claim 13, wherein the other data includes a name.

15. The method according to claim 10, further comprises:
storing a ring tone corresponding to the identification data in the memory;
retrieving the ring tone corresponding to the detected identification data; and
generating the retrieved ring tone.

16. The method according to claim 10, further comprises:
storing a vibrating pattern corresponding to the identification data;
retrieving the vibrating pattern corresponding to the detected identification data; and
generating the retrieved vibrating pattern.

17. The method according to claim 10, wherein the images are still images.

18. The controlling method according to claim 10, wherein the images include moving images.

19. In a communication apparatus having a memory for storing a plurality of images and other data in correspondence with identification data, a control unit comprising:
a detector configured to detect the identification data in an incoming call to the communication apparatus;
a retrieving unit configured to retrieve the images corresponding to the detected identification data from the memory; and
a display configured to display the retrieved images.

20. The control unit according to claim 19, wherein the identification data identifies a caller requesting voice communication with the communication apparatus.

21. The control unit according to claim 19, wherein the identification data identifies a caller requesting message communication with the communication apparatus.

22. The control unit according to claim 19, wherein the retrieving unit retrieves the other data from the memory corresponding to the detected identification data, and the display alternates between displaying individual ones of the retrieved images and the retrieved other data.

23. The control unit according to claim 22, wherein the other data includes a name.

24. The control unit according to claim 19, wherein the other data includes a ring tone corresponding to the identification data and the retrieving unit retrieves the ring tone corresponding to the detected identification data and causes a ringing unit to generate the retrieved ring tone.

25. The control unit according to claim 19, wherein the other data includes a vibrating pattern corresponding to the identification data and the retrieving unit retrieves the vibrating pattern corresponding to the detected identification data and causes a vibrating unit to generate the retrieved vibrating pattern.

26. The control unit according to claim 19, wherein the images are still images.

27. The control unit according to claim 19, wherein the images include moving images.
